(19) United States
(12) Patent Application Publication
(10) Pub. No.: US 2006/0233042 A1
(43) Pub. Date: Oct. 19, 2006

(54) APPARATUS FOR HOMOGENIZATION AND/OR DISPERSION OF FREE-FLOWING MATERIAL

(75) Inventors: Marko Buchholz, Marklohe (DE); Martin Helck, Bremen (DE)

Correspondence Address: Henry M. Feiereisen;Henry M. Feiereisen, LLC, Suite 4714, 350 Fifth Avenue, New York, NY, 10118, US

(73) Assignee: Ekato Unimix GmbH, Bremen (DE)

(21) Appl. No.: 11/279,679

(22) Filed: Apr. 13, 2006

(30) Foreign Application Priority Data
Apr. 13, 2005 (DE) 10 2005 017 075.7

(51) Int. Cl. B01F 15/02

(52) U.S. Cl. 366/136; 366/152.1

(57) ABSTRACT

Apparatus for homogenizing and/or dispersing free-flowing material, in particular liquid or pasty material, includes a container for receiving free-flowing material, a homogenizing and/or dispersing device, and a feed pump for transferring the material in a flow direction from a container outlet to an inlet of the homogenizing and/or dispersing device. The feed pump and the homogenizing and/or dispersing device are hereby operated by separate drives. An outlet of the homogenizing and/or dispersing device is connected to an inlet of the container via a recirculation system for optional return flow of material. Disposed between an outlet of the feed pump and the inlet of the homogenizing and/or dispersing device is a sensor for controlling operation of the feed pump in response to a flow characteristic of the material and/or a process parameter so that a material flow to the homogenizing and/or dispersing device is maintained constantly under a supply pressure.

### CROSS-REFERENCES TO RELATED APPLICATIONS

This application claims the priority of German Patent Application, Serial No. 10 2005 017 075.7, filed Apr. 13, 2005, pursuant to 35 U.S.C. 119(a)-(d), the content of which is incorporated herein by reference.

### BACKGROUND OF THE INVENTION

The present invention relates to an apparatus for homogenizing and/or dispersing free-flowing material, such as liquid or pasty material.

Nothing in the following discussion of the state of the art is to be construed as an admission of prior art.

Homogenizing and/or dispersing devices, also called homogenizer, are used in particular to making viscous or highly viscous products, ointments, pastes, gels, cremes, dough, mayonnaise or the like in the pharmaceutical, cosmetic, chemical and food industries. European Pat. Publ. No. 0 801 974 B1 describes a homogenizing and dispersing device which includes a multistage rotor/stator assembly to enable multiple recirculation of material at varying turbulence through the homogenizing and/or dispersing device. Typically, the homogenizer is disposed at or in the bottom area of a container or mixing vessel, which is filled with material to a desired level. Material flow exiting the homogenizing and/or dispersing device can be returned to the container in proximity of the container bottom or at an upper area of the container.

Heretofore, common to all homogenizing and/or dispersing devices is the problem of cavitation when the conveying capacity of the homogenizing and/or dispersing device exceeds the amount of material flowing from the container outlet to the homogenizing and/or dispersing device. Cavitation is experienced in particular when during a cleaning cycle for example the cleaning liquid, such as water, is heated and circulated because the steam pressure of the cleaning liquid is quickly reached. Associating a pump unit to the homogenizing and/or dispersing device could not overcome this problem. To the contrary, it caused another problem in connection with the introduction of additives, such as liquids, powdery substances or the like, because these additives can be drawn back into the material container when material is aspirated in the area of the homogenizing and/or dispersing device. Depending on process conditions, it is even possible that powder is pulled back into the container.

It would therefore be desirable and advantageous to provide an improved apparatus for homogenizing and/or dispersing free-flowing material to obviate prior art shortcomings.

### SUMMARY OF THE INVENTION

According to one aspect of the present invention, an apparatus for homogenizing and/or dispersing free-flowing material, in particular liquid or pasty substances, includes a container for receiving free-flowing material, a homogenizing and/or dispersing device, a feed pump for transferring the material in a flow direction from a container outlet to an inlet of the homogenizing and/or dispersing device, a recirculation system for connecting an outlet of the homogenizing and/or dispersing device to an inlet of the container for optional return flow of material, a first drive for operating the feed pump, a second drive for operating the homogenizing and/or dispersing device, and a sensor disposed between an outlet of the feed pump and the inlet of the homogenizing and/or dispersing device for controlling operation of the feed pump in response to a flow characteristic of the material and/or a process parameter so that a material flow to the homogenizing and/or dispersing device is maintained constantly under a supply pressure.

The present invention resolves prior art problems by universally controlling and regulating the conveyance through the feed pump and the material treatment in the homogenizing and/or dispersing device independently from one another so that the feed pump and the homogenizing and/or dispersing device can individually be optimized to the process conditions. The process can be carried out viscose-dependent and can be best suited to shear-sensitive products, such as gels, mascara etc. Thus, the feed pump can be operated in a way to best suit the type of material involved such as viscous or highly viscous substances to ensure that the amount of material flowing to the homogenizing and/or dispersing device is always greater than the conveying capacity of the homogenizing and/or dispersing device. As a consequence of the universal control and regulating capability, the material retention time is shorter and the material flow is subjected to less shearing stress so that the material can be treated gently. The flow rate through the homogenizing and/or dispersing device can be optimized and enhanced in dependence on the type of material so that the presence of cavitation is prevented because the material flow is transported to the homogenizing and/or dispersing device constantly under the supply pressure. Cavitation and accompanying noise generation can be prevented even during a cleaning cycle because the high pump capacity can be adjusted independently from the flow rate through the homogenizing and/or dispersing device. This can be implemented by the provision of the sensor which controls operation, especially the rotation speed, of the feed pump.

According to another feature of the present invention, a feed unit may be provided for supply of an additive of liquid or powdered composition into the homogenizing and/or dispersing device. An undesired return of drawn additives back to the material container is hereby prevented by the universal control and regulating capability, as described above.

According to another feature of the present invention, the sensor may be a pressure sensor.

According to another feature of the present invention, a branch conduit may be disposed in flow direction upstream of the inlet of the homogenizing and/or dispersing device, and a valve for opening and closing the branch conduit. In particular when shear-sensitive products are involved, such as gels, mascara, etc., the use of an openable and closeable branch conduit upstream of the homogenizing and/or dispersing device enables, after undergoing a sufficient homogenization and/or dispersion, a discharge of the product by means of the feed pump, without requiring the product to pass through the homogenizing and/or dispersing device again.

According to another feature of the present invention, the feed pump may be a centrifugal pump. A centrifugal pump can be optimized to suit the targeted conveying action, also as far as viscose of the material being treated is concerned. Such a centrifugal pump is also applicable for conveying viscous and especially highly-viscous substances and can be operated to subject the material being treated to no or only insignificant shearing stress.

According to another feature of the present invention, the feed pump may have a tangential outlet in fluid communication with the inlet of the homogenizing and/or dispersing device. In this way, the conveyance of material in the direction to the homogenizing and/or dispersing device can be implemented in the feed pump without loss.

According to another feature of the present invention, the recirculation system may be constructed to extend from the outlet of the homogenizing and/or dispersing device to an area near the container outlet and/or to an upper area of the container, suitably at a level above a current material level. In this way, an internal or external recirculation can be realized in a simple constructive manner.

According to another feature of the present invention, an agitator may be disposed in the container and constructed for conveying material in an axial and/or radial direction to realize an even mixing of material already in the container. Depending on the construction of the agitator, an internal recirculation to an area in proximity of the container outlet may be sufficient by itself in some cases so that the need for an external recirculation can be eliminated.

According to another feature of the present invention, a frequency converter may be provided for controlling the first and second drives for the feed pump and the homogenizing and/or dispersing device, respectively. This allows a sensitive control and regulation of the drives.

According to another feature of the present invention, the pump capacity of the feed pump and the conveying capacity of the homogenizing and/or dispersing device are variable independently from one another. As a result, the pump capacity of the feed pump and the conveying capacity of the homogenizing and/or dispersing device can be universally changed and adapted with consideration of the material viscosity and/or energy density.

According to another feature of the present invention, the feed unit for introducing the additive may be constructed to respond to underpressure determined by the sensor. This allows a sensitive supply of amounts of additive, and additives are prevented from migrating directly into the container because an abrupt return flow is effectively suppressed.

According to another feature of the present invention, the retention time in the shearing zone of the homogenizing and/or dispersing device can be adjusted and varied by the pump capacity (rotation speed) of the feed pump to thereby adjust an energy density. In this way, a heating of the material as it passes through the homogenizing and/or dispersing device can be limited because the retention time can be suited and modified in the homogenizing and/or dispersing device in dependence of the viscosity of the material flow for example.

According to another feature of the present invention, the feed pump and the homogenizing and/or dispersing device may be combined to form a compact unitary structure having a flange for attachment to the container. The provision of such a unitary structure is not only compact and space-saving but easy to maintain.

### BRIEF DESCRIPTION OF THE DRAWING

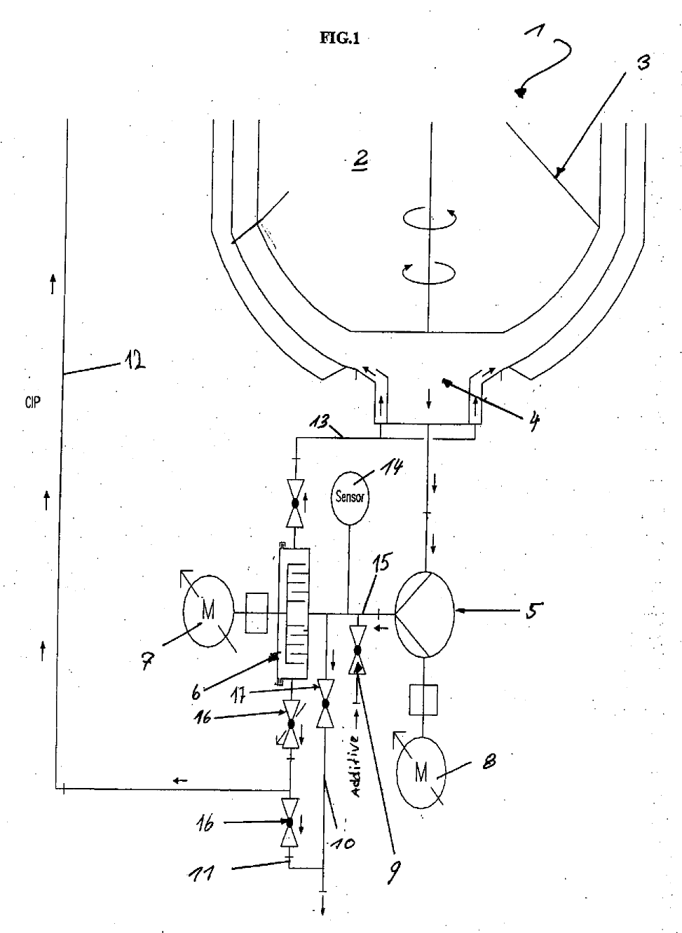

Other features and advantages of the present invention will be more readily apparent upon reading the following description of currently preferred exemplified embodiments of the invention with reference to the accompanying drawing, in which the sole FIG. 1 is a schematic illustration of an apparatus for homogenizing and/or dispersing free-flowing material according to the present invention.

### DETAILED DESCRIPTION OF PREFERRED EMBODIMENTS

The depicted embodiment is to be understood as illustrative of the invention and not as limiting in any way. It should also be understood that the drawings are not necessarily to scale and that embodiments are sometimes illustrated by graphic symbols, phantom lines, diagrammatic representations and fragmentary views. In certain instances, details which are not necessary for an understanding of the present invention or which render other details difficult to perceive may have been omitted.

Turning now to FIG. 1, there is shown a schematic illustration of an apparatus for homogenizing and/or dispersing free-flowing material, such as liquid or pasty substances, in accordance with the present invention, generally designated by reference numeral 1. The apparatus 1 includes a container 2, shown schematically here only in part, for accommodating the material being treated. Disposed in the container 2 is an agitator 3, indicated only schematically, which is constructed to force the material to flow in preferably axial and/or radial direction. The container 2 has a container outlet 4 which fluidly communicates with a feed pump 5 having an outlet which is connected via a conduit 15 to a homogenizing and/or dispersing device 6, shown only schematically and sometimes referred to as homogenizer or disperser. The homogenizing and/or dispersing device 6 is driven by a motor 7 whereas the feed pump 5 is driven by a separate motor 8. In other words, the homogenizing and/or dispersing device 6 and the feed pump 5 are operated by separate drives and thus can be operated independently from one another. The flow direction of material is shown in FIG. 1 by way of arrows.

Disposed between the outlet of the feed pump 5 and an inlet of the homogenizing and/or dispersing device 6 is a feed unit 9 for introduction of an additive, such as liquid or powdery substances for admixture to the material flow in the conduit 15 prior to entry of the material into the homogenizing and/or dispersing device 6. Further connected to the conduit 15 upstream of the homogenizing and/or dispersing device 6 is a branch conduit 10 via which treated material can be discharged. A conduit 11 branches into the conduit 10 for connection to the outlet of the homogenizing and/or dispersing device 6 to allow discharge of material from the homogenizing and/or dispersing device 6 via a respective valve assembly 16.

The apparatus 1 further includes a recirculation system for material exiting the homogenizing and/or dispersing device 6. The recirculation system is comprised of an external circulation line 12 and/or an internal circulation line 13. The external circulation line 12 branches off conduit 11 at the outlet side of the homogenizing and/or dispersing device 6 and extends to an interior space of the container 2. Suitably, the circulation line 12 enters the container 2 above the level of the material in the container 2. The internal circulation line 13, which may be employed as an alternative to or in concert with the external circulation line 12, extends from an outlet side of the homogenizing and/or dispersing device 6 to an area of the container 2 near the container outlet 4 such that the material flow is radially deflected, i.e. the material enters the container 2 in radial direction.

Disposed in the conduit 15 between the feed pump 5 and the homogenizing and/or dispersing device 6 is a sensor 14, which may be constructed as a pressure sensor. As an alternative, the sensor 14 may also be constructed to operate in response to a volume flow. When configured as a pressure sensor, the sensor 14 ascertains the pressure of the material flow in the conduit 15 prior to entry into the homogenizing and/or dispersing device 6. When the sensor 14 is constructed to detect underpressure conditions for example, the feed unit 9 for introducing liquid or powdery substances can be activated, without running the risk that additives supplied by the feed unit 9 are able to migrate into the interior space of the container 2. In addition, the sensor 14 is constructed to separate the control operation of the drive motors 7 and 8 for the feed pump 5 and the homogenizing and/or dispersing device 6, respectively. In other words, the sensor 14 is able to adjust and control the drive motors 7, 8 in such a manner that in dependence on the flow characteristics of the material and the material flow, the conveyance of the material flow in conduit 15 to the homogenizing and/or dispersing device 6 is constantly under a supply pressure. As a consequence, presence of cavitation can be effectively prevented.

Currently preferred is a construction of the feed pump 5 in the form of a centrifugal pump which has a tangential outlet in fluid communication with the inlet side of the homogenizing and/or dispersing device 6. The centrifugal pump 5 enables conveyance of material from the container outlet with little shearing stress. Thus, the centrifugal pump 5 is especially useful for shear-sensitive substances.

When operating the apparatus using the internal circulation line 13, it may be advantageous to prevent multiple passage of material through the homogenizing and/or dispersing device 6. In this case, valve 17 is actuated to allow discharge of material through the conduit 10, whereby the feed pump 5 is operated for allowing material discharge.

While in accordance with the present invention, the homogenizing and/or dispersing device 6 and the feed pump 5 can be operated independently from one another, the provision of the sensor 14 ensures a continuous operation of the feed pump 5 in such a manner that the material flow in the conduit 15 to the inlet side of the homogenizing and/or dispersing device 6 is constantly under a certain variable supply pressure. In this way, the apparatus 1 for homogenizing and/or dispersing free-flowing substances allows universally controllable material flow conduction within the system, optionally in combination with the external and/or internal circulation.

Although not shown in detail, the homogenizing and/or dispersing device 6 and the feed pump 5 may be combined to form a compact unitary structure to thereby provide an overall space-saving configuration of the apparatus 1 which is easy to maintain.

An unillustrated control unit is further provided to operatively connect the sensor 14 to frequency converters of the drive motors 7 and 8 so that it is possible to not only control the individual drive parameter of feed pump 5 and homogenizing and/or dispersing device 6 variably and separately from one another but also to ensure that the feed pump 5 maintains the material flow under supply pressure at the entry to the homogenizing and/or dispersing device 6 at all variable operating conditions. In addition, the pump capacity of the feed pump 5 and the retention time in the shearing zone of the homogenizing and/or dispersing device 6 can be suited to one another so as to optimize the process control by adjusting the energy density.

While the invention has been illustrated and described in connection with currently preferred embodiments shown and described in detail, it is not intended to be limited to the details shown since various modifications and structural changes may be made without departing in any way from the spirit of the present invention. The embodiments were chosen and described in order to best explain the principles of the invention and practical application to thereby enable a person skilled in the art to best utilize the invention and various embodiments with various modifications as are suited to the particular use contemplated.

What is claimed is:

1. Apparatus for homogenizing and/or dispersing free-flowing material, in particular liquid or pasty material, comprising:
a container for receiving free-flowing material;
a homogenizing and/or dispersing device;
a feed pump for transferring the material in a flow direction from a container outlet to an inlet of the homogenizing and/or dispersing device;
a recirculation system for connecting an outlet of the homogenizing and/or dispersing device to an inlet of the container for optional return flow of material;
a first drive for operating the feed pump;
a second drive for operating the homogenizing and/or dispersing device; and
a sensor disposed between an outlet of the feed pump and the inlet of the homogenizing and/or dispersing device for controlling operation of the feed pump in response to a flow characteristic of the material and/or a process parameter so that a material flow to the homogenizing and/or dispersing device is maintained constantly under a supply pressure.

2. The apparatus of claim 1, further comprising a feed unit for supply of an additive of liquid or powdered composition into the homogenizing and/or dispersing device.

3. The apparatus of claim 1, wherein the sensor is a pressure sensor.

4. The apparatus of claim 1, further comprising a branch conduit disposed in flow direction upstream of the inlet of the homogenizing and/or dispersing device, and a valve for opening and closing the branch conduit.

5. The apparatus of claim 1, wherein the feed pump is a centrifugal pump.

6. The apparatus of claim 1, wherein the feed pump has a tangential outlet in fluid communication with the inlet of the homogenizing and/or dispersing device.

7. The apparatus of claim 1, wherein the recirculation system is constructed to extend from the outlet of the homogenizing and/or dispersing device to an area in proximity of the container outlet and/or to extend from the outlet of the homogenizing and/or dispersing device to an upper area of the container.

8. The apparatus of claim 7, wherein the material is returned into the container at a level above a material level.

9. The apparatus of claim 1, further comprising an agitator disposed in the container and constructed for conveying material in an axial and/or radial direction.

10. The apparatus of claim 1, further comprising a frequency converter for controlling the first drive and a frequency converter for controlling the second drive.

11. The apparatus of claim 1, wherein the feed pump has a pump capacity and the homogenizing and/or dispersing device has a conveying capacity, wherein the pump capacity and the conveying capacity are variable independently from one another.

12. The apparatus of claim 2, wherein the feed unit is constructed to respond to underpressure determined by the sensor.

13. The apparatus of claim 1, wherein the homogenizing and/or dispersing device has a shearing zone, wherein the feed pump controls a retention time of material in the shearing zone through adjustment of a pump capacity of the feed pump to thereby adjust an energy density.

14. The apparatus of claim 13, wherein the retention time is controlled by adjusting a rotation speed of the feed pump.

15. The apparatus of claim 1, wherein the feed pump and the homogenizing and/or dispersing device are combined to form a compact unitary structure having a flange for attachment to the container.

16. The apparatus of claim 1, further comprising a control unit for automatically operating the feed pump such that the material flow to the homogenizing and/or dispersing device is maintained constantly under the supply pressure.

17. The apparatus of claim 16, wherein the control unit operates the feed pump in dependence on a speed of the homogenizing and/or dispersing device.
